(19) United States
(12) Patent Application Publication
(10) Pub. No.: US 2026/0137581 A1
(43) Pub. Date: May 21, 2026

(54) COMPRESSION GARMENT WITH ENHANCED COOLING AND MASSAGING FEATURES

(71) Applicant: Julius Zorn, Inc., Cuyahoga Falls, OH (US)

(72) Inventor: Greg BIDDULPH, Cuyahoga Falls, OH (US)

(73) Assignee: Julius Zorn, Inc., Cuyahoga Falls, OH (US)

(21) Appl. No.: 19/120,265

(22) PCT Filed: Oct. 2, 2023
(86) PCT No.: PCT/US2023/075693

§ 371 Date: Apr. 11, 2025

Related U.S. Application Data
(60) Provisional application No. 63/379,978, filed on Oct. 18, 2022.

(51) Int. Cl. A61H 7/00

(52) U.S. Cl. CPC A61H 7/001; A61H 2201/0214; A61H 2201/1261; A61H 2201/165; A61H 2201/168; A61H 2201/1695; A61H 2201/1697

(57) ABSTRACT

A compression garment wrapped around a limb of a user includes a foam layer having a first face configured to oppose the limb of the user when wrapped around the limb of the user, and a second face opposite the first face. The foam layer includes a first plurality of perforations extending through the foam layer from the first face to the second face. The compression garment also includes a moisture wicking layer on the first face of the foam layer that wicks moisture in a transverse direction away from the first face of the foam layer, and to spread the moisture in a lateral direction within the moisture wicking layer perpendicular to the transverse direction, to wick moisture to a portion of the first plurality of perforations to exit the foam layer.

### RELATED APPLICATIONS

This application claims priority to and the benefit of U.S. Provisional Application No. 63/379,978, filed on Oct. 18, 2022, entitled “COMPRESSION GARMENT”, which is herein incorporated by reference in its entirety.

### FIELD OF INVENTION

The present application relates generally to compression garments, and more particularly to devices and methods for providing comfort and multiple therapeutic effects to a user wearing a compression garment.

### BACKGROUND OF THE INVENTION

Therapeutic compression garments are worn to prevent the build-up of fluid in the limbs, a condition commonly referred to as edema, to alleviate various types of vascular insufficiencies. Persons who may use such a garment include post-surgical patients, obese persons, and persons with ailments that impede circulation, such as Chronic Venous Insufficiency, Lymphedema, and Diabetes. Compression garments improve circulation and prevent fluid from collecting in the lower limb portions, such as in the legs, feet and ankles (lower extremity compression garment) or arm or hands (upper extremity compression garment). By compressing the limb, circulation can be improved and limb size can be contained by reducing the propensity toward fluid build-up. Compression garments may also alleviate pain associated with poor circulation or edema, and aid in the prevention and treatment of ulcers and other issues that can result from poor circulation in the limbs.

For example, many patients experiencing Lymphedema may also experience fibrosis. Fibrosis is the thickening, hardening, or scarring of tissues in the body as a result of surgery or other medical treatments, or other causes such as injury, infection, or inflammation. In addition or alternatively to compression therapy, medial massage including manual lymphatic drainage may be used to reduce swelling and help break down the fibrotic tissue. Additionally, chipped foam or sheets of textured foam/lymph pads may be inserted between a compression garment and the skin to help break down fibrotic tissue.

Compression garments often come in two forms: elastic and short-stretch (also known as inelastic) compression garments. Elastic compression garments come in the form of hosiery or socks that are designed to provide a stated level of pressure for a person's limb size. Short-stretch garments come in the form of a garment intended to be wrapped around a person's limb and pressure is determined by applying tension to the straps of the garment. Short-stretch compression garments may be constructed using a solid, open, or closed cell foam middle layer covered by a plush outer layer adhered to at least one side of the foam middle layer. Patients may find these garments to be unbreathable and, therefore, uncomfortable.

To optimize the effectiveness of such short-stretch compression garments, the garments must be worn by patients in compliance with appropriate compression levels and for a sufficient amount of time to achieve the therapeutic benefits. Accordingly, comfort of the compression garment when worn by the patient is important to encourage patients to comply with such requirements. As referenced above, short-stretch compression garments in particular may be unbreathable and therefore uncomfortable. Moisture build-up under the garment and against the skin creates discomfort and can lead to rash or skin irritation, which ultimately reduces the propensity of a user to wear the garment sufficiently to maximize the therapeutic effects.

In the fields of clothing or non-medical garments, “wicking” fabrics are known. Wicking fabrics “wick” or draw moisture away from the skin to be evaporated from the outer surface of the fabric. Such fabrics commonly are used, for example, in clothing worn while doing athletic or fitness type activities to allow sweat or other moisture to be drawn from a user's skin and evaporated from the garment. The result of the wicking action is to provide cooling and drying effects as moisture is drawn away from the skin and through the garment, and then evaporated from the garment's outer surface into the environment. Wicking fabrics, however, have not been employed effectively in compression garments. To be effective, the wicking fabric must be exposed to the environment to permit evaporation of the moisture drawn from the skin. A short-stretch compression garment, however, employs a generally unbreathable foam layer that would need to overlie any wicking fabric layer. The conventional foam layer, therefore, being not significantly permeable to moisture, would not permit the wicked moisture to evaporate out from the garment. As a result, the moisture would build up in the wicking fabric and be trapped against the user's skin, potentially even exacerbating the negative effects of conventional foam materials used in compression garments.

### SUMMARY OF THE INVENTION

The present disclosure describes a compression garment having improved properties for thermal management and therapeutic benefits, resulting in a more comfortable and effective compression garment for a user having various types of vascular insufficiencies and/or fibrosis. Specifically, the compression garment includes a wicking layer overlayed by a foam layer, wherein the foam layer includes perforations that allow moisture to travel from a user's skin to an outside of the compression garment. In particular, the moisture wicking layer is applied to the user's skin when the compression garment is wrapped around a limb of the user. The moisture wicking layer wicks moisture from the user's skin to the foam layer, and the moisture can then evaporate out of the garment through the perforations in the foam layer, thereby providing the cooling and drying advantages associated with wicking fabrics that otherwise could not be achieved using conventional foam layers for compression garments. The compression garment may additionally or alternatively be embossed and include one or more raised portions configured to contact the user's skin when the compression garment is wrapped around the limb of the user to provide a massaging effect that aids in the breakdown of fibrotic tissue.

Therefore, an aspect of the invention is a compression garment configured to be wrapped around a limb of a user. The compression garment includes a foam layer having a first face configured to oppose the limb of the user when the compression garment is wrapped around the limb of the user, and a second face opposite the first face. The foam layer includes a first plurality of perforations extending through the foam layer from the first face to the second face. The compression garment also includes a moisture wicking layer on the first face of the foam layer. The moisture wicking layer is configured to wick moisture in a transverse direction away from the first face of the foam layer, and to spread the moisture in a lateral direction within the moisture wicking layer perpendicular to the transverse direction, to wick moisture to a portion of the first plurality of perforations.

Another aspect of the invention is a compression garment configured to be wrapped around a limb of a user which includes a foam layer including a first face configured to oppose the limb of the user when the compression garment is wrapped around the limb of the user, and a second face opposite the first face. The foam layer includes a first plurality of perforations extending through the foam layer from the first face to the second face, and one or more raised portions having one or more relief portions interposed between the one or more raised portions on the first face of the foam layer.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1A is a side view of a component of a compression garment.

FIG. 1B is another side view of components of a compression garment.

FIG. 2 is a cross-sectional view of a component of a compression garment including a first plurality of perforations.

FIG. 3 is a plan view of a component of a component of a compression garment including a first plurality of perforations.

FIG. 4A is a cross-sectional view of components of a compression garment including a first plurality of perforations and a second plurality of perforations.

FIG. 4B is another cross-sectional view of components of a compression garment including a first plurality of perforations and a second plurality of perforations.

FIG. 5A is a cross-sectional view of a compression garment.

FIG. 5B is another cross-sectional view of a compression garment.

FIG. 5C is another cross-sectional view of a compression garment including a first plurality of perforations.

FIG. 5D, FIG. 5E, FIG. 5F, and FIG. 5G are a sequence of figures that demonstrate an example of wicking action of the compression garment of FIG. 5C.

FIG. 6A is another cross-sectional view of a compression garment including a first plurality of perforations.

FIG. 6B is another cross-sectional view of a compression garment including a first plurality of perforations and a second plurality of perforations.

FIG. 6C is another cross-sectional view of a compression garment including a first plurality of perforations and a second plurality of perforations.

FIG. 7A is another cross-sectional view of a compression garment including one or more raised portions.

FIG. 7B is another cross-sectional view of a compression garment including one or more raised portions.

FIG. 7C is another cross-sectional view of a compression garment including one or more raised portions.

FIG. 7D is another cross-sectional view of a compression garment including one or more raised portions.

FIG. 8A is another cross-sectional view of a compression garment including one or more raised portions and a first plurality of perforations.

FIG. 8B is another cross-sectional view of a compression garment including one or more raised portions and a first plurality of perforations.

FIG. 8C is another cross-sectional view of a compression garment including one or more raised portions and a first plurality of perforations.

FIG. 8D is another cross-sectional view of a compression garment including one or more raised portions, a first plurality of perforations and a second plurality of perforations.

FIG. 8E is another cross-sectional view of a compression garment including one or more raised portions, a first plurality of perforations and a second plurality of perforations.

FIG. 8F is another cross-sectional view of a compression garment including one or more raised portions, a first plurality of perforations and a second plurality of perforations.

FIG. 8G is another cross-sectional view of a compression garment including one or more raised portions, a first plurality of perforations and a second plurality of perforations.

FIG. 8H is a cross-sectional view of a compression garment including one or more raised portions and a first plurality of perforations.

FIG. 9A is a plan view of a compression garment having one or more raised portions.

FIG. 9B is another plan view of a compression garment having one or more raised portions.

FIG. 9C is another plan view of a compression garment having one or more raised portions.

FIG. 9D is another plan view of a compression garment having one or more raised portions.

FIG. 9E is another plan view of a compression garment having one or more raised portions.

FIG. 9F is another plan view of a compression garment having one or more raised portions.

FIG. 9G is another plan view of a compression garment having one or more raised portions.

### DETAILED DESCRIPTION

Embodiments of the present application will now be described with reference to the drawings, wherein like reference numerals are used to refer to like elements throughout. It will be understood that the figures are not necessarily to scale.

Embodiments of the present application include a short-stretch compression garment to be wrapped around a limb of a user, having improved properties for thermal management and therapeutic benefits, resulting in a more comfortable and effective compression garment for a user having various types of vascular insufficiencies and/or fibrosis. Specifically, the compression garment includes a moisture wicking layer overlayed by a foam layer, wherein the foam layer includes perforations that allow moisture to travel from a user's skin to an outside of the compression garment. In particular, the moisture wicking layer is applied to the user's skin when the compression garment is wrapped around a limb of the user. The wicking layer wicks moisture from the user's skin to the foam layer, and the moisture can then evaporate out of the garment via the perforations in the foam layer, thereby providing the cooling and drying advantages associated with wicking fabrics that otherwise could not be achieved using conventional foam layers. The compression garment foam layer may be an open or closed cell foam layer, whereby an open cell configuration may provide better breathability when the compression garment is wrapped around the limb of the user, or a closed cell configuration may provide greater stiffness and containment, depending upon the nature of a particular usage. The foam layer additionally or alternatively may be embossed on a first face of the foam layer that is configured to oppose a user's limb when the compression garment is wrapped around a limb of a user, to provide a massaging effect to break down fibrotic tissue that may be present in the limb of the user.

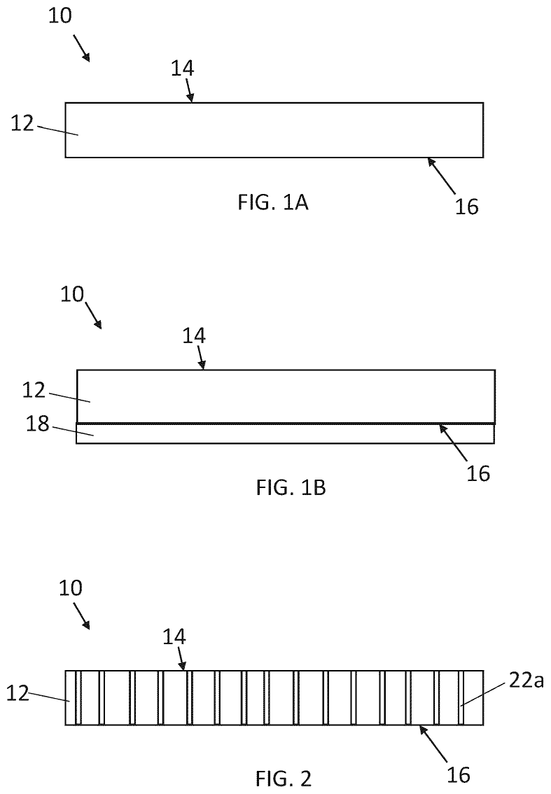

FIG. 1A depicts a side view of a component of a compression garment 10 constituting an open cell or closed cell foam layer 12. Open cell foam is more porous and may therefore provide greater breathability, while closed foam is generally more dense and less porous but may provide greater stiffness and containment for compression garments. The foam layer 12 has a first face 14 configured to oppose the limb of the user when the compression garment 10 is wrapped around the limb of the user, and a second face 16 opposite the first face 14. The foam layer 12 may have a thickness in the range of 1 mm to 3 mm, for example 1.2 mm or 1.5 mm. An open cell foam layer 12 may be thicker than a closed cell foam layer 12 to meet the correct stretch properties of the compression garment 10. As further detailed below, the configuration of the open cell foam layer 12 in accordance with embodiments of the present application provides enhanced breathability of the compression garment 10 over conventional garments, as air and moisture can move more freely through the foam layer 12 configured as an open cell layer. This promotes a cooling effect on the user's limb when the compression garment 10 is wrapped around the limb of the user, and the airflow through the compression garment 10 prevents the user's limb from being overheated.

As depicted in FIG. 1B, the compression garment 10 may also include an outer fabric layer 18 on the second face 16 of the foam layer 12. The outer fabric layer 18 may be made of a plush material. A fastener (not pictured) may be affixed to the outer fabric layer 18 for fixing the compression garment 10 in a wrapped position when the compression garment 10 is wrapped around the limb of the user.

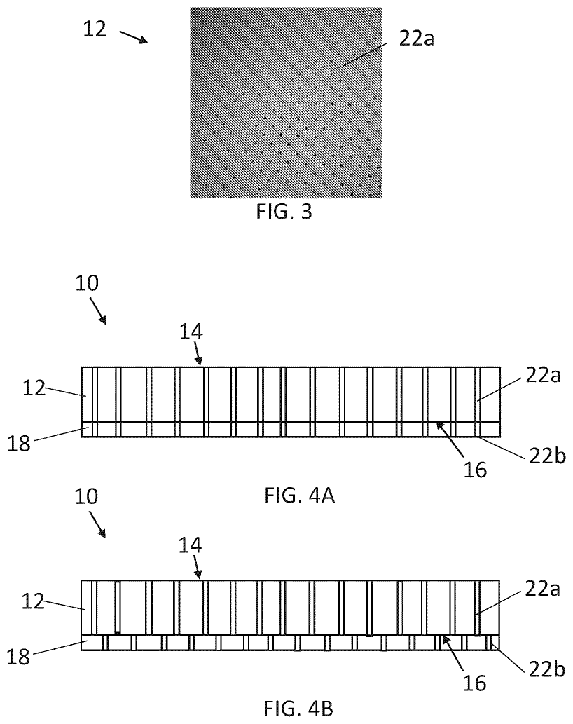

As depicted in the cross-sectional view of FIG. 2, the foam layer 12 is perforated and includes a first plurality of perforations 22a extending through an entire thickness of the foam layer 12 from the first face 14 to the second face 16. The perforations 22a may be arranged in an organized pattern on the foam layer 12, as depicted for example in the plan view of FIG. 3, or may be randomly arranged. In an embodiment depicted in FIGS. 4A and 4B, in which the compression garment 10 also includes the outer fabric layer 18, the outer fabric layer 18 may also be perforated and include a second plurality of perforations 22b. For example, as depicted in FIG. 4A, the second plurality of perforations 22b and the first plurality of perforations 22a may be formed together and aligned to extend through both of the foam layer 12 and the outer fabric layer 18. Additionally or alternatively, as depicted in FIG. 4B, the second plurality of perforations 22b may be offset with respect to the first plurality of perforations 22a. The first plurality of perforations 22a and the second plurality of perforations 22b aid in the breathability of the compression garment 10, as air and moisture are able to move freely through the perforations 22a, 22b having a cooling and drying effect on the user's limb when the compression garment 10 is wrapped around the limb of the user, thereby preventing the user's limb from being overheated or irritated by build-up of moisture.

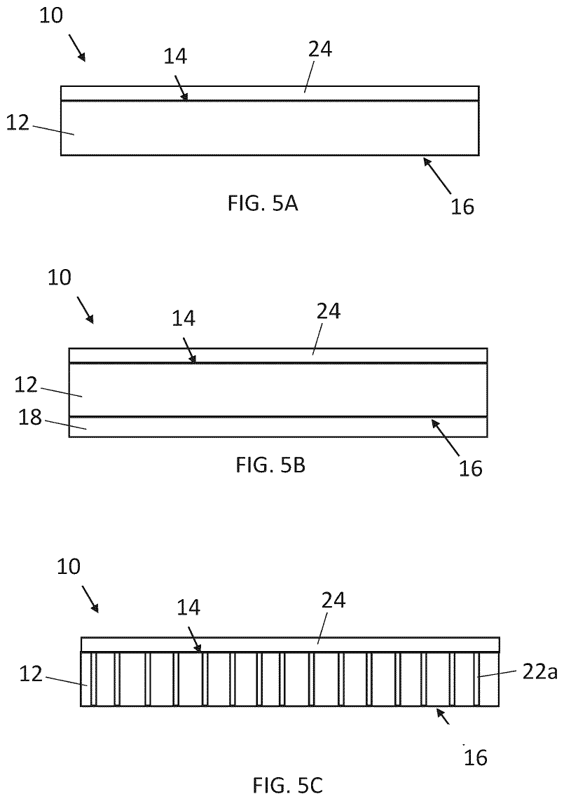

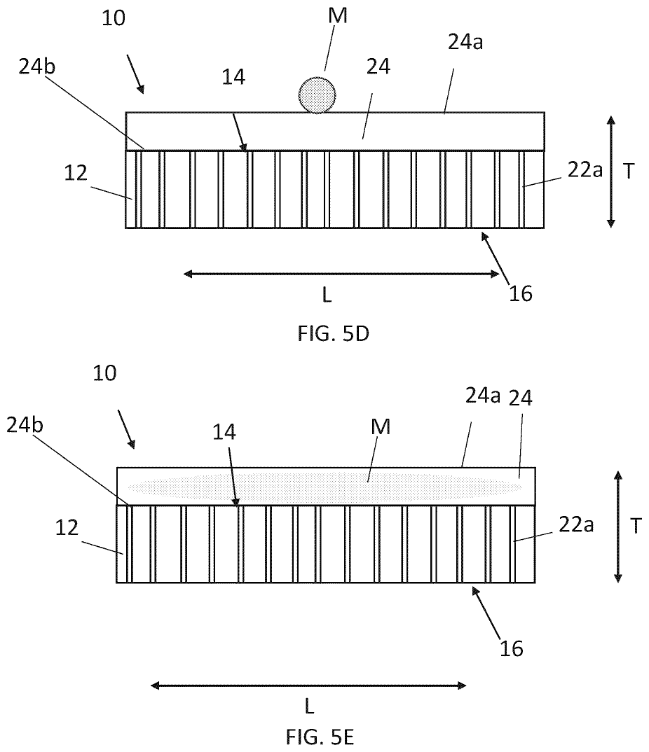

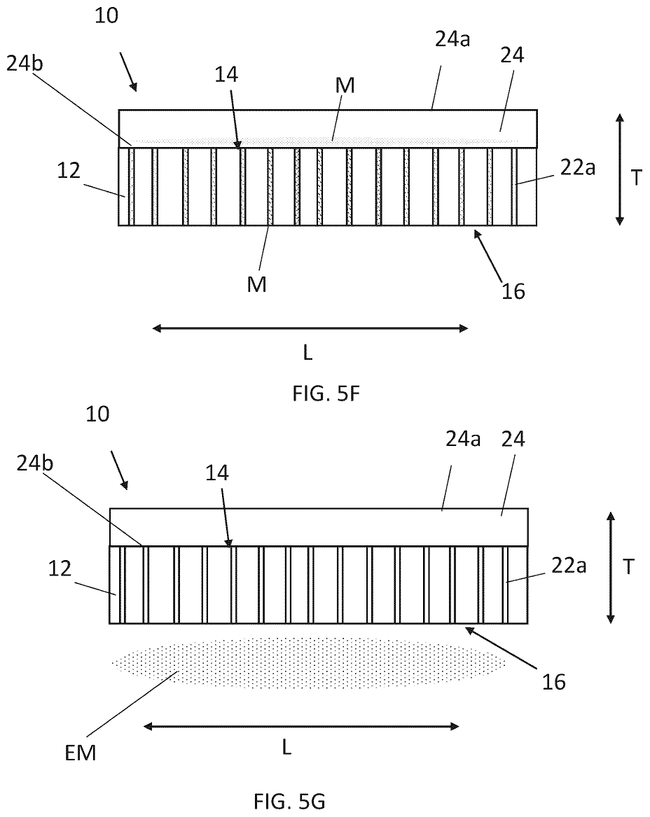

The compression garment 10 according to any embodiment described above may further include a moisture wicking layer 24 on the first face 14 of the foam layer 12, as depicted in FIGS. 5A-5C . The moisture wicking layer 24 is configured to be in contact with the limb of the user when the compression garment is wrapped around the limb of the user and may therefore be made with a material having skin compatibility. A moisture wicking layer 24 is made of fabric that has moisture management properties that, for example, enables the moisture wicking layer 24 to wick moisture away from the limb of the user. Specifically, the moisture wicking layer 24 may be configured to wick or move moisture from the skin on the limb of the user through the moisture wicking layer 24 to the first face 14 of the foam layer 12. As the foam layer 12 includes the first plurality of perforations 22a, the moisture then reaches at least a portion of the first plurality of perforations 22a in the foam layer 12 and can travel from the first face 14 of the foam layer 12, through the portion of the first plurality of perforations 22a, to the second face 16 of the foam layer 12 to be evaporated outside of the compression garment 10.

To further enhance the cooling effect of the compression garment 10, the moisture wicking layer 24 may be made of a cooling material, such as a nylon and polyester blended material that natively is cool to the touch. In exemplary embodiments, the cooling material further may have cooling minerals infused therein, such as metal or comparable particulates known in the art that are natively cool to the touch to provide a cooling effect on the skin. In this manner, a combination of the wicking action with a natively cool material of the moisture wicking layer 24 provides a resulting combined cooling, wicking, and drying effect to enhance the comfort of the user. The moisture wicking layer 24 having moisture management and/or cooling properties, in combination with the foam layer 12 having the first plurality of perforations 22a, and optionally in combination with the outer fabric layer 18 having the second plurality of perforations 22b, together promote enhanced breathability and comfort to the user when the compression garment 10 is wrapped around the limb of the user.

FIGS. 5D-5G are a sequence of figures that demonstrate an example of wicking action in connection with the compression garment of FIG. 5C. Such figures define a transverse direction “T” that is perpendicular to the inner and outer surfaces of the layers of the compression garment 10 (e.g., perpendicular to first and second faces 14 and 16 of the foam layer), and thus also would be generally perpendicular to the skin of the user when the compression garment is worn. Such figures also define a lateral direction “L” that is parallel to the inner and outer surfaces of the layers of the compression garment (e.g., parallel to first and second faces 14 and 16 of the foam layer), and thus also generally runs in a direction along the surfaces of the compression garment 10. Accordingly, the lateral direction L is perpendicular to the transverse direction T.

FIG. 5D depicts an exemplary droplet of moisture “M”. For example, the moisture M may be sweat or other moisture that originates at the interface of the user's skin and the compression garment 10. As such, the droplet of moisture M initially is at an inner surface 24a of the moisture wicking layer 24 that is positioned against a user's skin when the compression garment 10 is worn. FIG. 5E illustrates the initial wicking action of the moisture wicking layer 24. The moisture wicking layer 24 is configured to wick or draw in the moisture M in the transverse direction T away from the inner surface 24a of the wicking layer 24 toward an outer surface 24b of the wicking layer 24 opposite from the inner surface 24a. In addition, as the moisture M is drawn into the wicking layer 24, the wicking layer 24 further is configured to spread the moisture M within the wicking layer 24 in the lateral direction L. It will be appreciated that FIG. 5E is a two-dimensional representation, and thus the spreading is laterally in two dimensions within the wicking layer 24 (i.e., the spreading would occur within the wicking layer 24 also “into and out of the page”). As the moisture M is drawn in transversely away from the inner surface towards the outer surface 24b of the wicking layer 24, and further is spread laterally within the wicking layer 24, the moisture M comes in contact with at least a portion of the plurality of first perforations 22a within the foam layer 12.

As seen in FIG. 5F, as the wicking action draws the moisture M to the plurality of first perforations 22a in the foam layer 12, the moisture M enters at least a portion of first perforations 22a at the first face 14 and travels to the second face 16. As shown in FIG. 5G, once the moisture M reaches the second face 16 of the foam layer 12, the moisture then can exit from, such as for example evaporate from, the foam layer 12 of the compression garment 10 to the outside environment (evaporated moisture being denoted “EM” in FIG. 5G). With such evaporation, the combination of the wicking layer 24 with a perforated foam layer 12 provides a cooling and drying effect that otherwise could not occur with conventional foam layers that would trap the moisture in the wicking layer and against the user's skin. As referenced above, if the wicking layer further is made of a natively cool material, a combination of cooling, wicking, and drying is achieved for enhanced comfort of the compression garment 10.

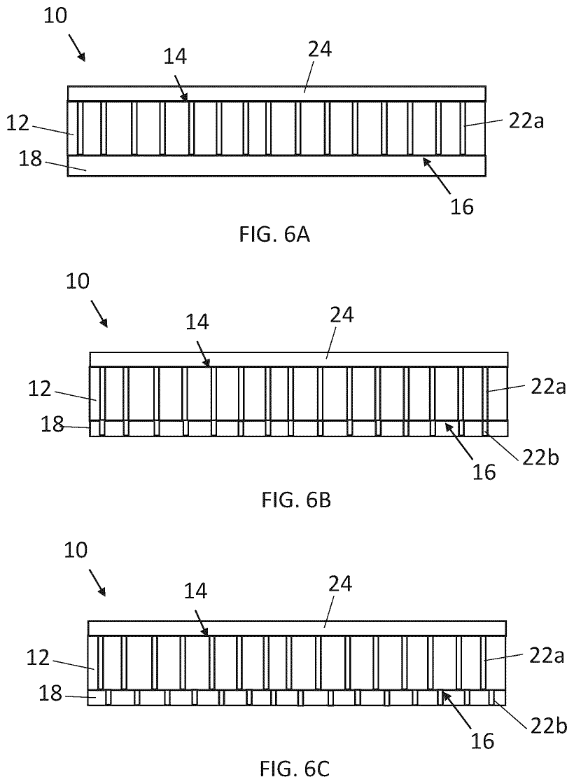

FIGS. 6A-6C depict an embodiment having the outer fabric layer 18 in combination with the wicking layer 24. The wicking action described above would operate comparably as described above whereby the moisture would exit the foam layer 12 and travel into the outer fabric layer 18. In an embodiment in which outer fabric layer 18 includes the second plurality of perforations 22b (see again FIGS. 4A-4B), the moisture further may then travel through a portion of the second plurality of perforations 22b to be evaporated to the outside environment.

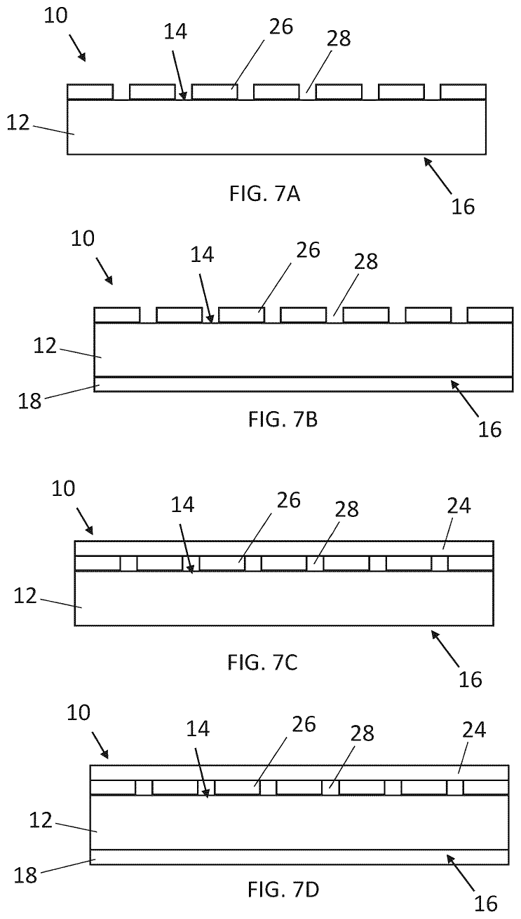

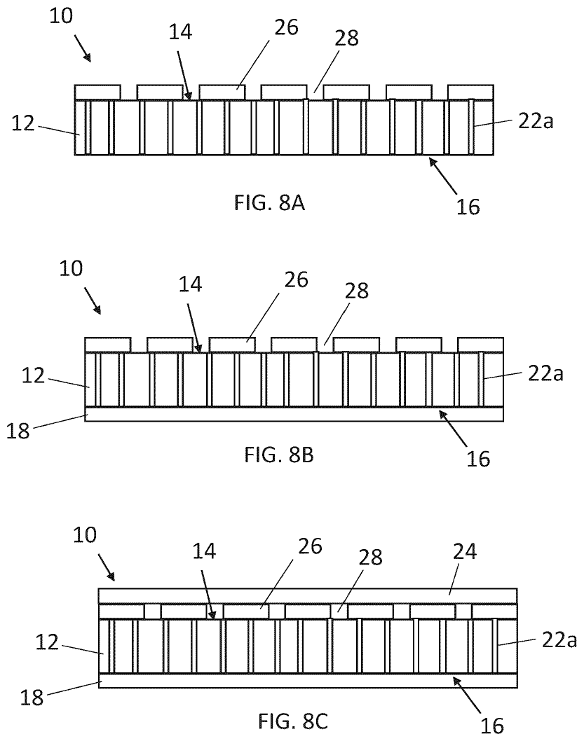

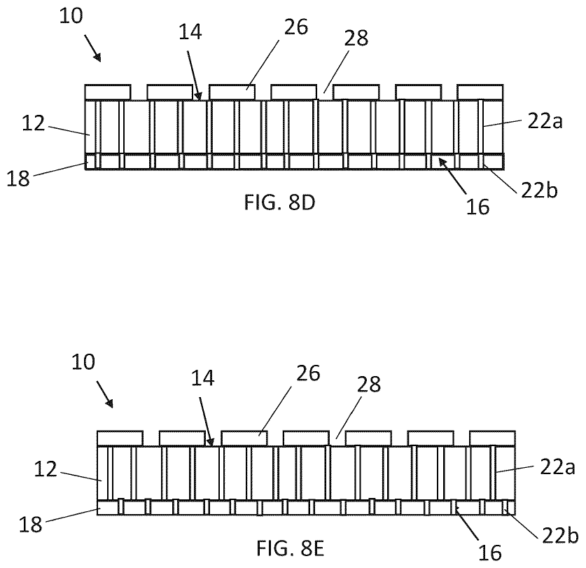

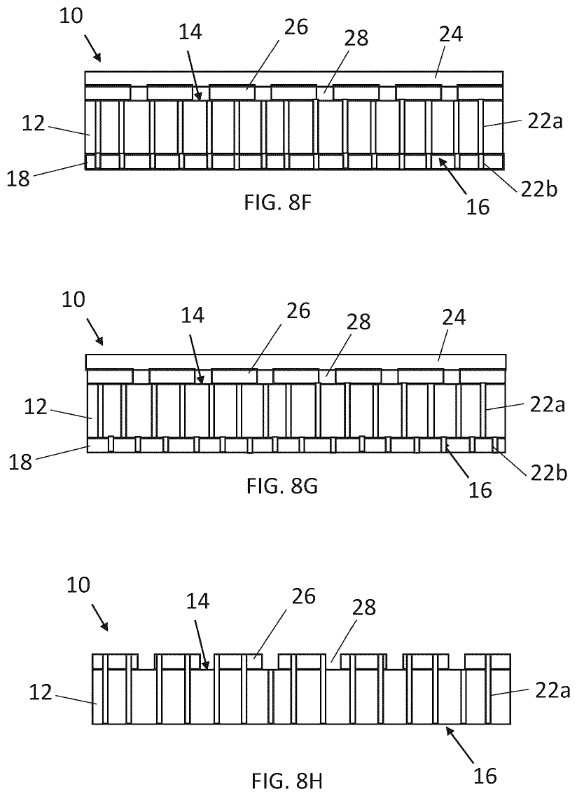

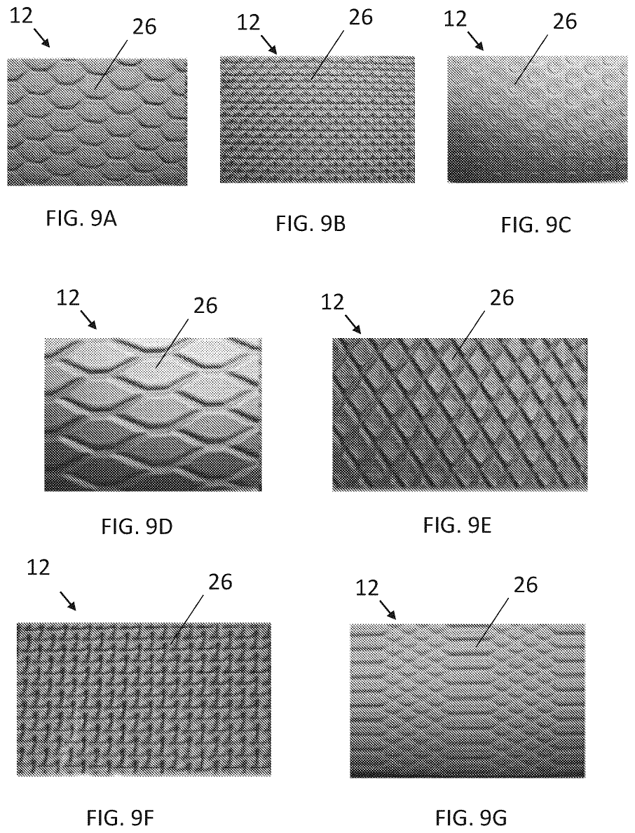

FIGS. 7A-8H depict various embodiments in which the foam layer 12 of the compression garment 10 is additionally or alternatively embossed on the first face 14 of the foam layer 12. Specifically, the first face 14 of the foam layer 12 according to any of the above-described embodiments may include one or more raised portions 26 having one or more relief portions 28 interposed between the one or more raised portions 26. The one or more raised portions 26 may include a plurality of discrete raised portions 26, or may embody a single continuous raised pattern on the first face 14 of the foam layer 12. For example, FIGS. 9A-G depict various embodiments and patterns of the one or more raised portions 26. The one or more raised portions 26 may have a thickness up to 1.0 mm. The plurality of raised portions 26 may each be the same size and shape, as depicted in FIGS. 9A-F, or may be of different size and shapes, as depicted in FIG. 9G. The one or more raised portions 26 are configured to oppose and put pressure on the user's limb when the compression garment 10 is wrapped around the limb of the user and provide a massaging effect on the user's limb as the user moves around. That is, the one or more raised portions 26 and the one or more relief portions 28 are configured to help direct fluid out of swollen areas and create a micro-massage to soften and break down hardened areas of fibrotic tissue that may be present in the limb of the user.

As depicted in FIGS. 7A-D, the compression garment 10 may include the one or more raised portion 26 with or without the outer fabric layer 18 and/or the moisture wicking layer 24. As depicted in FIGS. 7A and 7B, for example, the one or more raised portions 26 may be configured to directly contact the limb when the compression garment 10 is wrapped around the limb of the user. However, as depicted in FIGS. 7C and 7D, when the compression garment 10 includes the moisture wicking layer 24, and the one or more raised portions 26 underlie the moisture wicking layer 24 and do not directly contact the user's limb when the compression garment 10 is wrapped around the limb of the user.

As depicted in FIGS. 8A-G, the compression garment 10 may also include the one or more raised portions 26 with or without the first plurality of perforations 22a and/or the second plurality of perforations 22b. When the compression garment includes the first plurality of perforations 22a in the foam layer 12, the first plurality of perforations 22a may extend through the entire thickness of the one or more raised portions 26, as depicted representatively in FIG. 8H (which also may apply to any embodiment depicted in FIGS. 8A-G).

A compression garment configured to be wrapped around a limb of a user includes a foam layer having a first face configured to oppose the limb of the user when the compression garment is wrapped around the limb of the user, and a second face opposite the first face. The foam layer includes a first plurality of perforations extending through the foam layer from the first face to the second face. The compression garment also includes a moisture wicking layer on the first face of the foam layer. The moisture wicking layer is configured to wick moisture in a transverse direction away from the first face of the foam layer, and to spread the moisture in a lateral direction within the moisture wicking layer perpendicular to the transverse direction, to wick moisture to a portion of the first plurality of perforations.

The moisture wicking layer may be configured to wick moisture away from the limb of the user through the moisture wicking layer such that the moisture travels from the first face of the foam layer, through the portion of the first plurality of perforations to the second face of the foam layer to exit the foam layer, such as for example, by evaporating from the foam layer.

The moisture wicking layer may be made of a cooling material.

The cooling material of the moisture wicking layer may include cooling minerals.

The moisture wicking layer may be made with a material having skin compatibility.

The compression garment may further include an outer fabric layer on the second face of the foam layer.

The outer fabric layer may include a second plurality of perforations extending through the outer fabric layer, wherein the moisture travels from through a portion of the second plurality of perforations to exit the outer fabric layer, such as for example, evaporating from the outer fabric layer.

The second plurality of perforations of the outer fabric layer may be aligned with the first plurality of perforations of the foam layer.

The second plurality of perforations of the outer fabric layer may be offset with respect to the first plurality of perforations of the foam layer.

The outer fabric layer may be made of a plush material.

The foam layer may be embossed and have one or more raised portions on the first face of the foam layer, and one or more relief portions interposed between the one or more raised portions.

The one or more raised portions may include a plurality of discrete raised portions.

A compression garment configured to be wrapped around a limb of a user includes a foam layer including a first face configured to oppose the limb of the user when the compression garment is wrapped around the limb of the user, and a second face opposite the first face. The foam layer includes a first plurality of perforations extending through the foam layer from the first face to the second face, and one or more raised portions having one or more relief portions interposed between the one or more raised portions on the first face of the foam layer.

The one or more raised portions may include a plurality of discrete raised portions.

The plurality of discrete raised portions may each be of the same size and shape.

The first plurality of perforations may extend through an entire thickness of the one or more raised portions.

The compression garment may further include a moisture wicking layer on the first face of the foam layer. The moisture wicking layer may be configured to wick moisture in a transverse direction away from the first face of the foam layer, and to spread the moisture in a lateral direction within the moisture wicking layer perpendicular to the transverse direction, to wick moisture to a portion of the first plurality of perforations.

The moisture wicking layer may be configured to wick moisture away from the limb of the user through the moisture wicking layer to the portion of the first plurality of perforations at the first face of the foam layer, such that the moisture travels from the first face of the foam layer through the portion of the first plurality of perforations to the second face of the foam layer to exit the foam layer, such as for example, by evaporating from the foam layer.

The moisture wicking layer may be made of a cooling material.

The cooling material of the moisture wicking layer may include cooling minerals.

The compression garment may further include an outer fabric layer on the second face of the foam layer.

The outer fabric layer may include a second plurality of perforations extending through the outer fabric layer, wherein the moisture travels from through a portion of the second plurality of perforations to exit the outer fabric layer, such as for example, evaporating from the outer fabric layer.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1-22. (canceled)

23. A compression garment configured to be wrapped around a limb of a user, the compression garment comprising:
a foam layer including a first face configured to oppose the limb of the user when the compression garment is wrapped around the limb of the user, and a second face opposite the first face, wherein the foam layer includes a first plurality of perforations extending through the foam layer from the first face to the second face; and
a moisture wicking layer on the first face of the foam layer, wherein the moisture wicking layer is configured to wick moisture in a transverse direction away from the first face of the foam layer, and to spread the moisture in a lateral direction within the moisture wicking layer perpendicular to the transverse direction, to wick moisture to a portion of the first plurality of perforations to exit the foam layer.

24. The compression garment according to claim 23, wherein the moisture travels from the first face of the foam layer through the portion of the first plurality of perforations to the second face of the foam layer to exit the foam layer.

25. The compression garment according to claim 23, wherein the moisture wicking layer is made of a cooling material.

26. The compression garment according to claim 23, wherein the moisture wicking layer is made with a material having skin compatibility.

27. The compression garment according to claim 23, further comprising an outer fabric layer on the second face of the foam layer.

28. The compression garment according to claim 27, wherein the outer fabric layer includes a second plurality of perforations extending through the outer fabric layer, wherein the moisture travels from through a portion of the second plurality of perforations to exit the outer fabric layer.

29. The compression garment according to claim 28, wherein the second plurality of perforations of the outer fabric layer are aligned with the first plurality of perforations of the foam layer.

30. The compression garment according to claim 28, wherein the second plurality of perforations of the outer fabric layer are offset with respect to the first plurality of perforations of the foam layer.

31. The compression garment according to claim 27, wherein the outer fabric layer is made of a plush material.

32. The compression garment according to claim 23, wherein the foam layer is embossed and has one or more raised portions on the first face of the foam layer and having one or more relief portions interposed between the one or more raised portions.

33. The compression garment according to claim 32, wherein the one or more raised portions include a plurality of discrete raised portions.

34. A compression garment configured to be wrapped around a limb of a user, the compression garment comprising:
a foam layer including a first face configured to oppose the limb of the user when the compression garment is wrapped around the limb of the user, and a second face opposite the first face, wherein the foam layer includes:
a first plurality of perforations extending through the foam layer from the first face to the second face; and
one or more raised portions having one or more relief portions interposed between the one or more raised portions on the first face of the foam layer.

35. The compression garment according to claim 34, wherein the one or more raised portions include a plurality of discrete raised portions.

36. The compression garment according to claim 35, wherein the plurality of discrete raised portions are each of the same size and shape.

37. The compression garment according to claim 34, wherein the first plurality of perforations extend through an entire thickness of the one or more raised portions.

38. The compression garment according to claim 34, further comprising a moisture wicking layer on the first face of the foam layer, wherein the moisture wicking layer is configured to wick moisture in a transverse direction away from the first face of the foam layer, and to spread the moisture in a lateral direction within the moisture wicking layer perpendicular to the transverse direction, to wick moisture to a portion of the first plurality of perforations to exit the foam layer.

39. The compression garment according to claim 38, wherein the moisture travels from the first face of the foam layer, through the portion of the first plurality of perforations to the second face of the foam layer to exit the foam layer.

40. The compression garment according to claim 38, wherein the moisture wicking layer is made of a cooling material.

41. The compression garment according to claim 34, further comprising an outer fabric layer on the second face of the foam layer.

42. The compression garment according to claim 41, wherein the outer fabric layer includes a second plurality of perforations extending through the outer fabric layer, wherein the moisture travels from through a portion of the second plurality of perforations to exit the outer fabric layer.
